(19) United States
(12) Patent Application Publication
(10) Pub. No.: US 2005/0053544 A1
(43) Pub. Date: Mar. 10, 2005

(54) Combustion process for the preparation of LiCoVO4

(75) Inventors: Chitra Srinivasan, Karaikudi (IN); Kalyani Palanichamy, Karaikudi (IN); Mohan Thyagarajan, Karaikudi (IN); Gopalakrishnan Krishnan, Karaikudi (IN); Gangadharan Ramaiyer, Karaikudi (IN); Julien Christian, Paris (FR)

Correspondence Address: LADAS & PARRY LLP, 26 WEST 61st STREET, NEW YORK, NY, 10023, US

(73) Assignee: COUNCIL OF SCIENTIFIC AND INDUSTRIAL RESEARCH

(21) Appl. No.: 10/870,078

(22) Filed: Jun. 17, 2004

Related U.S. Application Data
(63) Continuation of application No. 10/393,384, filed on Mar. 20, 2003, now abandoned.

(30) Foreign Application Priority Data
Mar. 28, 2002 (WO) PCT/IN02/00087

(51) Int. Cl. C01G 51/04; C01G 31/02

(52) U.S. Cl. 423/594.6; 423/594.8

(57) ABSTRACT

The present invention relates to a novel combustion process for the preparation of LiCoVO₄ useful as the cathode material in the rechargeable lithium-ion rocking chair cells by heating a composite mixture of LiNO₃.3H₂O, Co(NO₃)₂.6H₂O and NH₄VO₃ with urea in aqueous medium to obtain LiCoVO₄.

### FIELD OF THE INVENTION

The present invention relates to a combustion process for the preparation of LiCoVO₄ useful as the cathode material in the rechargeable lithium-ion rocking chair cells.

### BACKGROUND OF THE INVENTION

Studies in respect of the compound LiCoVO₄ which has an inverse spinel structure started in 1994. It was shown that this compound, prepared by heating LiCoO₂ and V₂O₃ at 800° C. for 24 h, can electrochemically intercalate and deintercalate lithium ions in non-aqueous electrochemical cells at about 4.2 V vs metallic lithium. [George Ting-Kuofey, Wu Li & J. R. Dahn, J. Electrochem. Soc., 141, 2279 (1994)]. This compound has also been prepared by heating Li₂CO₃, CoCO₃ and V₂O₅ at 600° C. for several days [C. Gonzalez, M. Gaitan, M. L. Lopez, M. L. Veija; R. Saez-puche, C. Pico J. Mat. Sci. 29, 3458(1994]. Recently, a two step process was reported in which freshly prepared LiCoO₂ (by heating a mixture of LiOH and COCO₃) was heated with NH₄VO₃ [Jooji and Teeinkew Fuei, JP 07, 320, 741 (95,320,741) (Cl. H01M4/58)]. All the above mentioned methods suffer from either phase purity or longer duration of heating at high temperature.

### OBJECTS OF THE INVENTION

The main object of the present invention is to provide a combustion process for the preparation of LiCoVO₄ useful as the cathode material in the rechargeable lithium-ion rocking chair cells which obviates the defects and drawbacks in other methods known in the literature.

### SUMMARY OF THE INVENTION

Accordingly, the present invention provides a combustion process for the preparation of LiCoVO₄ useful as the cathode material in the rechargeable lithium-ion rocking chair cells, comprising heating a composite mixture of LiNO₃.3H₂O, Co(NO₃)₂.6H₂O and NH₄VO₃ with urea in aqueous medium at a temperature of about 500° C. for about three hours to obtain LiCoVO₄.

In one embodiment of the invention, LiCoVO₄ is obtained in the single phase without impurities.

In another embodiment of the invention, LiNO₃.3H₂O in an amount of 0.025 mol is dissolved in a solution of aqueous ammonia in a quartz crucible, and NH₄VO₃ in an amount of 0.025 mol is slowly added as solid with simultaneous stirring and heating to a temperature of about 70° C. to completely dissolve NH₄VO₃, followed by the addition of Co(NO₃)₂.6H₂O in an amount of 0.025 mol and stoichiometric amount of urea in an amount of 0.05 mol.

### DETAILED DESCRIPTION OF THE INVENTION

LiNO₃.3H₂O (0.025 mol) was dissolved in a solution of aqueous ammonia in a quartz crucible. NH₄VO₃ (0.025 mol) was slowly added as solid with simultaneous stirring and heating to a temperature of about 70° C. to completely dissolve NH₄VO₃. Co(NO₃)₂.6H₂₀ (0.025 mol) and stoichiometric amount of urea (0.05 mol) were added to the above solution which resulted a brownish yellow colloidal suspension. Urea is added as an internal fuel for combustion [S. S. Manohar and K. C. Patil, J. Amer. Ceram. Soc. 75, 1012, (1992)]. This solution was slowly heated in a muffle furnace for 3 hours at 500° C. The contents were allowed to cool to room temperature on its own to obtain brown colour solid, confirmed as LiCoVO₄ from the XRD pattern of the powdered sample which showed the complete absence of the possible impurities of the metal oxides. The crystal parameters calculated from the powder pattern, assuming cubic settings, [a=8.26 Å; lit:a=8.27 Å. JCPDS No: 160668] confirmed the homogeneity (single phase) of the sample. An experiment carried out using Malvern 3600 Ec particle sizer showed the particle sizes of this compound to be in the range 3.0 mm to 28.1 mm. To test the product thus obtained for its battery activity, using this material as the cathode and lithium metal as anode, a coin type cell was fabricated with IM LiClO₄ dissolved in propylene carbonate (PC) as the electrolyte. This cell showed a voltage of 3.00 V.

The following examples are given by way of illustration of the present invention and should not be construed to limit the scope of the present invention.

### EXAMPLE I

| Materials used | Composition (in moles) |
|---|---|
| 1. LiNO₃.3H₂O | 0.025 |
| 2. Co(NO₃)₂.6H₂O | 0.025 |
| 3. NH₄VO₃ | 0.025 |
| 4. Urea | 0.05 |
| 5. Ammonia solution (2 M) | 15 ml |

Heating at 500° C. for 3 hours

| | |
|---|---|
| Product Results | |
| Product yield efficiency | 90% |
| Phase characterisation | single phase |
| Particle size at 800° C. | 3.0 mm to 28.1 mm |
| Cell Voltage of LiCoVO₄/Li | |
| in IM LiClO₄ in propylene | 3.00 V |
| Carbonate. | |

### EXAMPLE II

| Materials used | Composition (in moles) |
|---|---|
| 1. LiNO₃.3H₂O | 0.025 |
| 2. Co(NO₃)₂.6H₂O | 0.025 |
| 3. NH₄VO₃ | 0.025 |
| 4. Urea | 0.05 |
| 5. Ammonia solution (2 M) | 15 ml |

Heating at 500° C. for 3 hours

| | |
|---|---|
| Product Results | |
| Product yield efficiency | 90% |
| Phase characterisation | single phase |
| Particle size at 800° C. | 3.0 mm to 28.1 mm |
| Cell Voltage of LiCoVO₄/Li | |
| in IM LiClO₄ in propylene | 3.00 V |
| Carbonate. | |

Increased addition of the internal fuel does not change the properties of LiCoVO₄ whereas decreased amount of the same leads to incomplete reaction.

The main advantages of this invention are:

1. The inorganic materials used for the preparation of LiCoVO₄ which were in a uniform colloidal suspension produced the final product in a single phase
2. The product was obtained at a lower temperature in a shorter period of time.
3. The product is pure.

1. A combustion process for the preparation of LiCoVO₄ useful as the cathode material in the rechargeable lithium-ion rocking chair cells, said process comprising heating a composite mixture of LiNO₃.3H₂O, Co(NO₃)₂.6H₂O and NH₄VO₃ with urea in aqueous medium at 500° C. for three hours to obtain LiCoVO₄.

2. A process as claimed in claim 1 wherein LiCoVO₄ is obtained in the single phase without impurities.

3. A process as claimed in claim 1 wherein LiNO₃.3H₂O in an amount of 0.025 mol is dissolved in a solution of aqueous ammonia in a quartz crucible, and NH₄VO₃ in an amount of 0.025 mol is slowly added as solid with simultaneous stirring and heating to a temperature of about 70° C. to completely dissolve NH₄VO₃, followed by the addition of Co(NO₃)₂.6H₂O in an amount of 0.025 mol and stoichiometric amount of urea in an amount of 0.05 mol.
